(19) United States
(12) Patent Application Publication
(10) Pub. No.: US 2004/0138867 A1
(43) Pub. Date: Jul. 15, 2004

(54) System and method for modeling multi-tier distributed workload processes in complex systems

(76) Inventor: David Judson Simkins, Apalachin, NY (US)

Correspondence Address: MILES & STOCKBRIDGE PC, 1751 PINNACLE DRIVE, SUITE 500, MCLEAN, VA, 22102-3833, US

(21) Appl. No.: 10/341,507

(22) Filed: Jan. 14, 2003

(51) Int. Cl. G06F 9/45

(52) U.S. Cl. 703/22

(57) ABSTRACT

A method for modeling a distributed workload problem resolution process including building a topological model of a workload process comprising a plurality of hierarchical levels, each level comprising at least one node, and assigning at least one behavior to each node, the behavior configured to model a component of the problem resolution process, wherein at least one of the behaviors are configured to model a degree of merit. A degree of merit may include a level of data fusion, a level of automation, or a combination thereof.

A problem resolution process may be defined as a well-structured approach to solving a problem with available resources. Problem resolution processes are ubiquitous, and may comprise a variety of complexities, from the very simple to the very complex. For example, a local grocery store may have a simple, standardized process for resolving customer complaints, while a national emergency response system may be fairly complex.

In either situation, it is desirable to employ the most efficient means for resolution, whether creating a new problem resolution process or improving an existing one. Efficiency may be optimized by reducing workload and costs in reaching a resolution while maintaining a desirable level of accuracy.

With the intention of optimizing efficiency in a problem resolution process, it is often desirable to model the topography of the process for simulating actual, real-life conditions. Simulation models afford the ability to make changes to the model for analysis without affecting the real-world process. The costs incurred by making changes to the real-world process using a procedure such as, for example, a trial-and-error procedure, is eliminated. Furthermore, unwanted and unexpected results—and in the worst-case scenario, a catastrophic consequence crashing the entire process—are inherently reduced.

The invention disclosed herein provides an operations research method and system for modeling a multi-tiered, hierarchical problem resolution process. Any type of hierarchical problem resolution process in any environment varying within a spectrum of complexities may be modeled by the invention described herein. The modeling method and system provides an analysis for optimizing a desirable level of effectiveness for the processes of problem assessment, problem assignment, problem resolution, and the overall encompassing problem resolution process. The invention described herein measures varying degrees of data fusion employed in a model of a problem resolution process and effectiveness thereof. The invention described herein measures varying degrees of automation employed in a model of a problem resolution process and effectiveness thereof.

### BRIEF DESCRIPTION OF THE DRAWINGS

In the drawings, where like reference numbers refer to like elements throughout the several views:

FIG. 1 is a flow chart showing a method for modeling a problem resolution process according to one embodiment of the present invention;

FIG. 2 is a block diagram depicting a topological model according to one embodiment of the invention;

FIG. 3 is a block diagram depicting a topological model according to one embodiment of the invention;

FIG. 4 is a flow chart showing control flow of a dispatch behavior according to one embodiment of the invention;

FIG. 5 is a flow chart showing control flow of an assessment behavior according to one embodiment of the invention;

FIG. 6 is a flow chart showing control flow of an assignment behavior according to one embodiment of the invention;

FIG. 7 is a flow chart showing control flow of a resolution behavior according to one embodiment of the invention; and

FIG. 8 is a block diagram of a computer system for implementing and executing the method according to one embodiment of the invention.

### DETAILED DESCRIPTION OF THE INVENTION

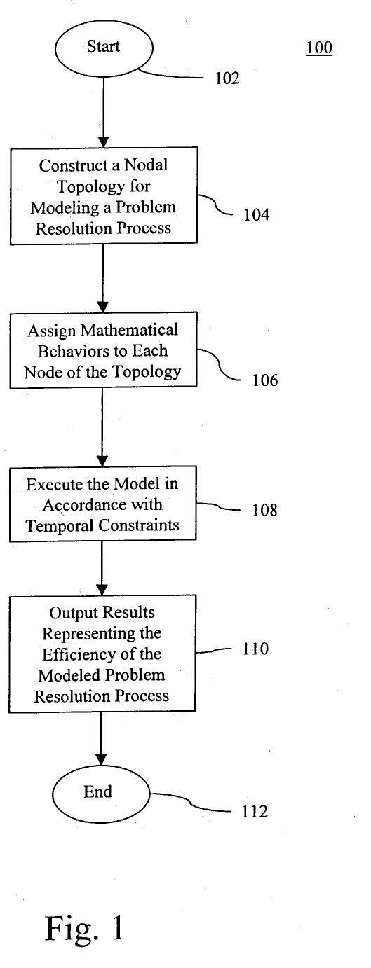

FIG. 1 shows a flow chart for modeling a problem resolution process in accordance with one embodiment of the present invention. A modeling method 100 is initiated at control block 102. At control block 104, a nodal topology is constructed for modeling a problem resolution process. Each node within the topology serves to simulate a particular event, action, or inaction of the problem resolution process. To efficiently model the event, action, or inaction at each node, mathematical behaviors are assigned to each node at control block 106. Probabilistic distributions, stochastic processes, or other types of discrete event mathematics may be employed to model the behavior at each node. At control block 108, the model executes for a predetermined period of time. The simulated time may have a proportional relationship to a much longer real-time analysis for modeling in an abbreviated time interval. Alternatively, a direct correspondence between simulation time and real-time may be utilized. These proportional and direct relationships depend on the problem resolution process being modeled. Results representing the level of efficiency of the resolution process are output at control block 110. The results that are output may vary according to the type of analysis being performed. This output may be in the form of a printed data sheet, a digital output, or any other type of human or machine-readable form. It is important to note that block 112 is the end of a single iteration of modeling method 100, and several iterations may be carried out in order to analyze modifications to the model for determining their resulting effects.

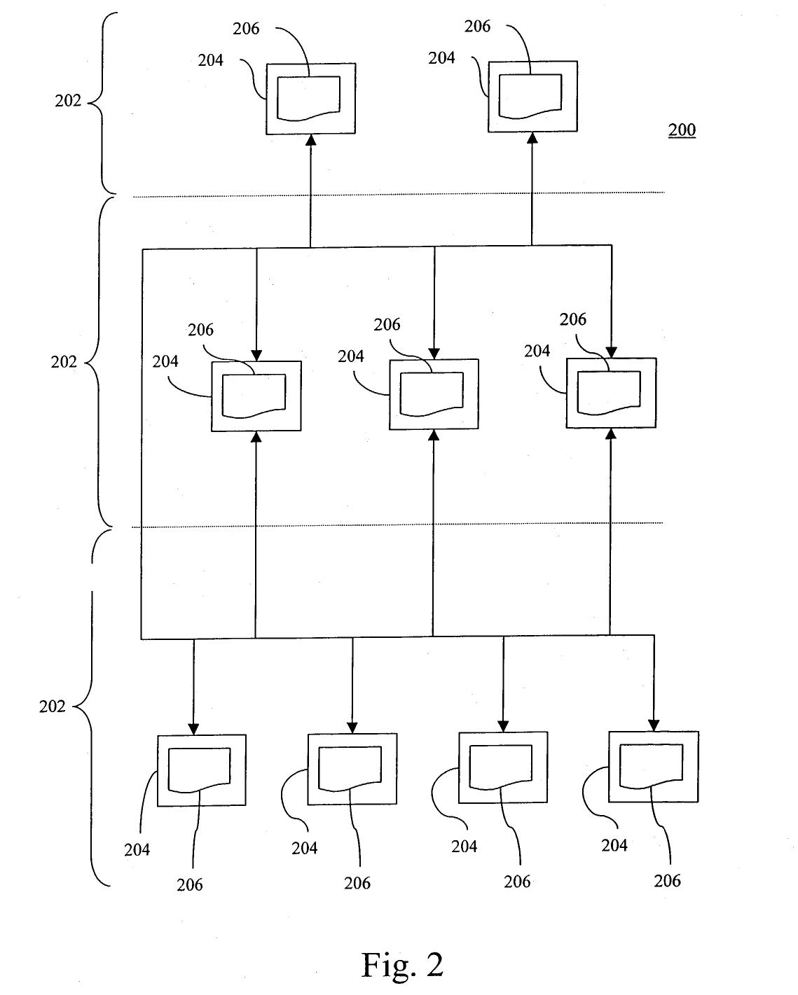

FIG. 2 shows a three-tiered, hierarchical model 200 of a problem resolution process. Each tier or level 202 represents a hierarchy in a hierarchical organizational approach to modeling. Each level 202 comprises at least one node 204. Nodes 204 are independent entities within the problem resolution process wherein one or more various actions, events, processes, or inactions may occur. A simulated problem may be introduced at any level 202 and at any node 204, wherein its introduction frequency and introduction node location depends on the problem resolution process being modeled. Each node 204 may be configured to route a problem or problem data to any other node 204 in model 200. The routes associated therewith vary with the problem resolution process being modeled. Any node 204 at any level 202 may be configured to ultimately resolve a problem.

Each node 204 has at least one behavior 206 associated therewith. Due to the complexity of many problem resolution processes, node 204 may comprise multiple behaviors 206. Behavior 206 may be configured to model a component of the problem resolution process, including actions, events, or inactions of the process. Both time and accuracy associated with each behavior are modeled as a stochastic process. Behavior 206 may be different for each node 204, or nodes may have similar behaviors. Multi-tiered, hierarchical problem resolution process model 200 may be modeled on a variety of simulation software packages of linear programming software packages. For example, the commercially available HyperformiX Strategizer software package may be used for such modeling purposes.

Behavior 206 may be configured to model a degree of merit, wherein the degree of merit includes a level of data fusion, a level of automation, or a combination thereof.

Data fusion is the matching of a set of data or patterns to a cause or symptom exhibited by a problem. Data fusion is therefore based on empirical data, and in the case of a problem resolution process, data fusion aims to decrease effectively the time and costs associated with seeking an appropriate resolution to the problem. Each behavior 206 may model a level of data fusion using known levels of data fusion in the problem resolution process or, alternatively, may model the level of data fusion on probabilistic distributions, stochastic processes, or random variability.

Data automation is the level of automatic, or self-operating, functionality within the problem resolution process. Each behavior 206 may model this level of simulated automation using known levels of automation in the actual problem resolution process or, alternatively, may model the level of automation on probabilistic distributions, stochastic processes, or random variability.

The accuracy of model 200 is dependent on the precision in which the actual problem resolution process is modeled. A stronger parallel between model 200 and the problem resolution process often results in more accurate simulation results. It is preferable that the individual(s) modeling a problem resolution process are knowledgeable with respect to the actual process, so that an accurate model is formed.

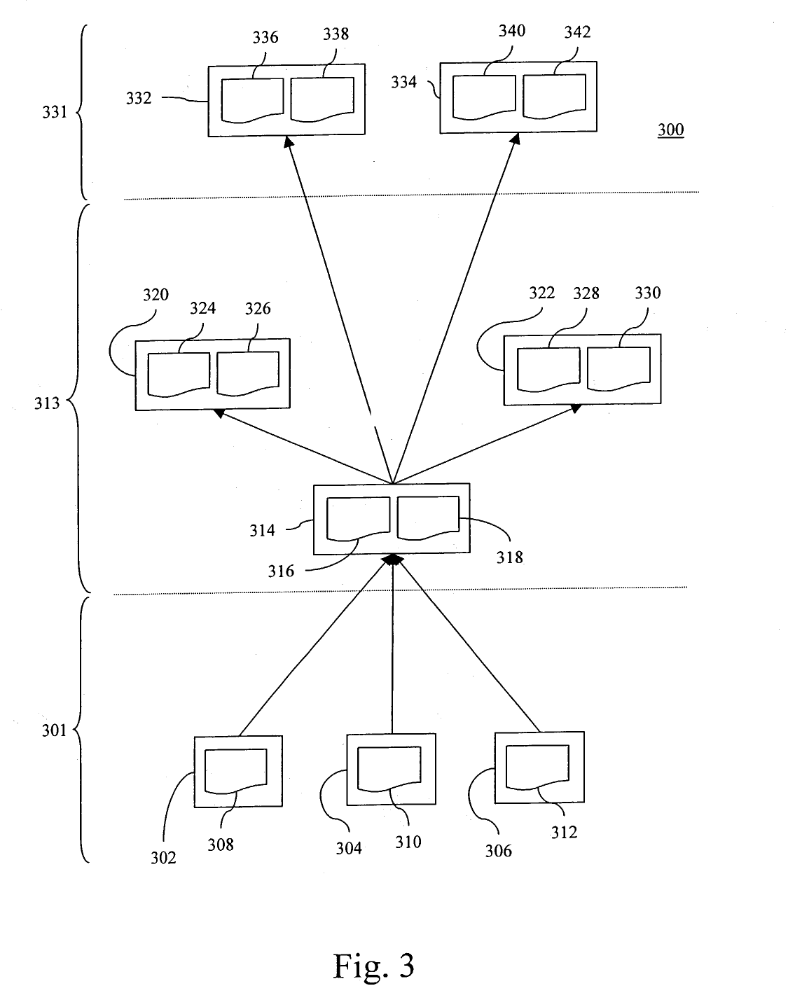

FIG. 3 illustrates one embodiment of a topological model 300 in accordance with the systems and methods described herein. Model 300 may be a more specific implementation of generic model 200 shown in FIG. 2. In the embodiment of FIG. 3, a problem resolution process is modeled to simulate an information technology help desk. In the present embodiment, the problem resolution process comprises a dispatch process, an assessment process, an assignment process, and a termination process. The assessment process is influenced by a degree of merit comprising both a level of data fusion and a level of automation. Simulated technology problems, such as computer hardware, computer software, human computer interface (HCI), and computer system problems, are introduced into model 300 for resolution by a help desk. It should be appreciated by one skilled in the art that the problem resolution process being modeled is by way of example, and in no way is intended to limit the scope of the invention. Other problem resolution processes may use the systems and methods of the present invention as described herein.

Model 300 simulates a multi-tier hierarchical help desk comprising three levels 301, 313, 331. Each level represents a different hierarchical level in the problem resolution process. In particular, level 301 models a local level in which a symptom is introduced into the resolution process by a user experiencing the problem. Level 301 comprises reporting and dispatching functions of the workload process. Local dispatchers easily and rapidly answer routine questions and may use a trouble-shooting guide. Information technology knowledge is limited at this local level. Level 313 models a regional level in which a regional analyst handles symptom assessment and symptom assignment functions and has software and hardware expertise to resolve software and hardware problems. The level of data fusion and the level of automation influence the simulation at level 313. Level 331 models an enterprise level in which a headquarters team of analysts has additional expertise and data to resolve system and HCI related problems and problems not solvable at the regional or local levels. Each higher-ordered hierarchical level 301, 313, 331 represents an increasing availability of resources, such as expertise, in the problem resolution process.

Level 301 comprises three dispatcher nodes 302, 304, 306, each node having an associated dispatch behavior 308, 310, 312, respectively. Model 300 simulates three types of incidents that the help desk may manage. These include a system degradation incident, a system crash incident, and a system integration or installation incident. Dispatch behavior 308 of node 302 is configured to introduce a system degradation incident, behavior 310 of node 304 is configured to introduce a system crash incident, and dispatch behavior 312 of node 306 is configured to introduce a system integration or installation incident. These incidents can be introduced at simulated time intervals using a probabilistic distribution, such as an exponential distribution, or other mathematical technique such as a stochastic process, or by using discrete event simulation techniques. It should be appreciated that incidents alternatively may be introduced at random. Incidents may be resolved at level 301 by a dispatcher, or they may propagate to level 313.

Level 313 comprises three regional analyst nodes 314, 320, 322. In particular, node 314 models assessment and assignment processes for those problems not resolved at level 301. Node 314 comprises assessment behavior 316 and assignment behavior 318. Assessment behavior 316 simulates a level of data fusion, a level of automation, or a combination thereof, which may be applied for optimizing the assessment accuracy. An accuracy of assessment indicator quantifies this level of accuracy assessment. Assignment behavior 318 conditionally assigns the problem to one of nodes 320, 322, 332, and 334 based on this indicator.

Node 320 and node 322 model the resolution of software and hardware problems, respectively. Software node 320 comprises resolution behaviors 324, 326. Resolution behavior 324 models a highly skilled software resolution group for resolving software problems assessed as difficult or having ill-defined circumstances. Resolution behavior 326 models a less skilled software resolution group for resolving software problems assessed as easier or having well-defined circumstances. Hardware node 322 comprises resolution behaviors 328, 330. Resolution behavior 328 models a highly skilled hardware resolution group for resolving hardware problems assessed as difficult or having ill-defined circumstances. Resolution behavior 330 models a less skilled hardware resolution group for resolving hardware problems assessed as easier or having well-defined circumstances.

Level 331 comprises two enterprise nodes 332, 334 that model the resolution of system and HCI problems, respectively. Similar to nodes 320, 322 of level 313, nodes 332, 334 each comprise two resolution behaviors. A resolution behavior 336 of system node 332 models a highly skilled system resolution group for resolving system problems assessed as difficult or having ill-defined circumstances. A resolution behavior 338 models a less skilled system resolution group for resolving system problems assessed as easier or having well-defined circumstances. Likewise, for HCI node 334, a resolution behavior 340 models a highly skilled HCI resolution group for resolving HCI problems assessed as difficult or having ill-defined circumstances, while a resolution behavior 342 models a less skilled HCI resolution group for resolving HCI problems assessed as easier or having well-defined circumstances.

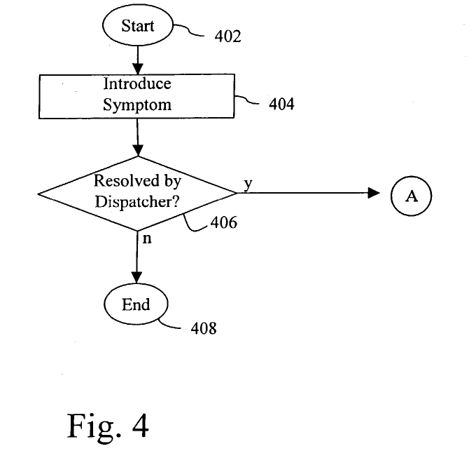

FIG. 4 shows a flow chart of control flow of dispatch behaviors 308, 310, 312 for modeling the dispatch process.

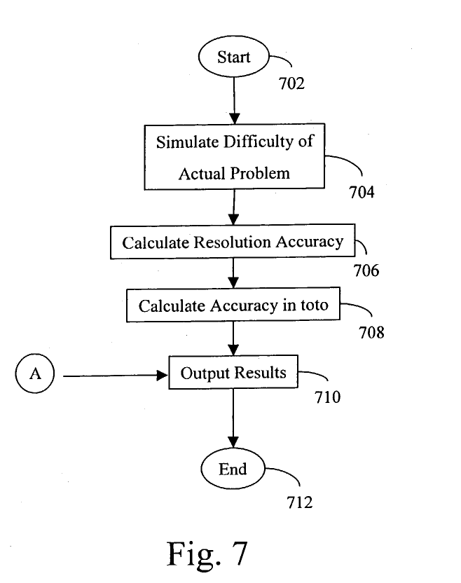

The dispatch process begins at control block 402 and proceeds to the introduction of an incident at control block 404. In model 300, such incidents are introduced at nodes 302, 304, 306 at tier 301 by behaviors 308, 310, 312 as a system degradation, a system crash, or a system integration or installation incident, respectively. In the problem resolution process, the problem may be resolved at this local level, represented by decision block 406, wherein the dispatcher can answer routine questions or those answerable using a straightforward, trouble-shooting guide. In the same way, behaviors 308, 310, 312 of model 300 may resolve the problem at level 301 using probabilistic distribution methods or other mathematics. If model 300 effectively resolves the problem at level 301, then the problem does not propagate past the originating node and control flow proceeds in accordance with the symbol [symbol] denoting continuation on FIG. 7. If the problem is not effectively resolved at decision block 406, the dispatch process ends at block 408 and the assessment process begins.

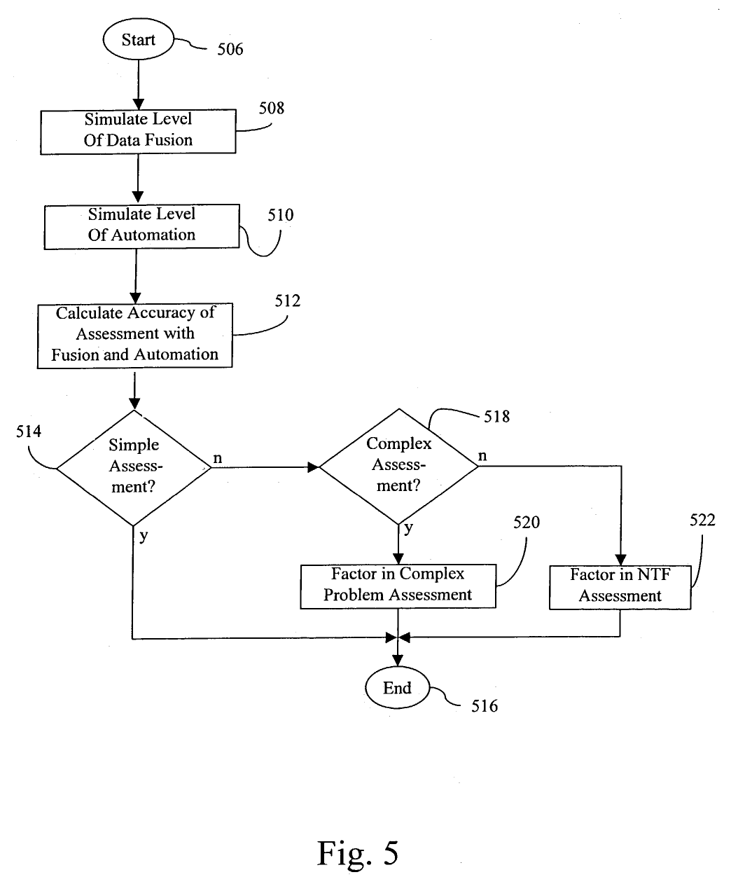

FIG. 5 shows a flow chart of control flow of assessment behavior 316 modeling the assessment process.

Beginning at block 506, assessment behavior 316 simulates a level of data fusion available for assessment at control block 508. For example, in accordance with the problem resolution process, there may be a high level of data fusion available for assessment if an exact or similar symptom has been previously reported to the help desk and empirical information pertaining thereto is available. Alternatively, there may be a low level of data fusion available for assessment if there is inadequate empirical information appropriate to the symptom. Existing fusion helps to assess the symptom under investigation, and having a high level of data fusion may lead to more accurate identification. Behavior 316 models a level of data fusion through a variety of methods, such as a uniform probability distribution, or any other mathematical generation method. It is important to note that the level of fusion simulated at this stage in the problem resolution processes assists only in the assessment of the symptom, and not resolution of the symptom. After the symptom has a level of data fusion assigned thereto, control flow proceeds to control block 510, wherein a level of automation for assessment of the symptom is simulated.

The level of automation is the degree to which the problem is assessed using automated, self-operating functionality. A high level of automation is associated with decreases in time to resolve and decreases in costs to resolve a problem. Alternatively, a low level of automation is associated with an increase in time to resolve and an increase in cost to resolve a problem. Similar in the way the level of data fusion is assigned to the symptom, a uniform probability distribution or other type of probability distribution or mathematical generation method of behavior 316 is utilized to model a simulated level of automation thereto. Also similar to the level of fusion, the level of automation modeled at this stage only assists in the assessment of the symptom at the regional level, and does not assist in resolution of the problem.

The level of data fusion or the level of automation that is modeled is indicative of a symptom as it is reported to the help desk. For example, a symptom reported by a user who provides a well-defined, concise explanation of the circumstances surrounding the incident will have a higher level of fusion and automation available for assessment than a symptom reported with poor information. By simulating various levels of fusion and automation, model 300 is modeling an assortment of symptoms and the quality of information reported by the user.

Proceeding to control block 512, an accuracy assessment indicator is derived from the level of data fusion and level of automation values previously determined at blocks 508, 510. This indicator is therefore conditioned on the level of data fusion available and the level of automation available for assessment. A well-defined description of the symptom or circumstances of the symptom would result in a high accuracy assessment because the level of data fusion or level of automation would be high. An ill-defined description of the symptom or circumstances of the symptom would result in a low accuracy assessment, since the level of data fusion and level of automation would be low. Therefore, the accuracy of assessment indicator simulates the degree of quality of the information describing the symptom and its circumstances reported by the user.

At decision block 514, an evaluation in model 300 is performed to determine if the assessment was done quickly by the assessor, representing a simple, easy assessment. In one embodiment, behavior 316 generates an assessment time based on an exponential (or more complex) probability distribution. This simulated assessment time is the time it takes for an assessor to resolve the problem. If this simulated time is less than a first predetermined threshold, then the assessment is considered a “simple” assessment and control flow continues to block 516, at which stage the assessment process is complete. If, however, the simulated assessment time is greater than the first predetermined threshold, then the simulated assessment time is compared to a second predetermined threshold at decision block 518 to determine whether a “complex” assessment or a No Trouble Found (NTF) situation is present. If the simulated assessment time is less than this second threshold, then a complex assessment variable is factored into the accuracy of assessment indicator at block 520.

If, at decision block 518, a complex assessment has not been simulated, then a NTF situation has occurred, in which a symptom could not be replicated by the assessor. A NTF variable is factored in to the accuracy of assessment indicator at block 522.

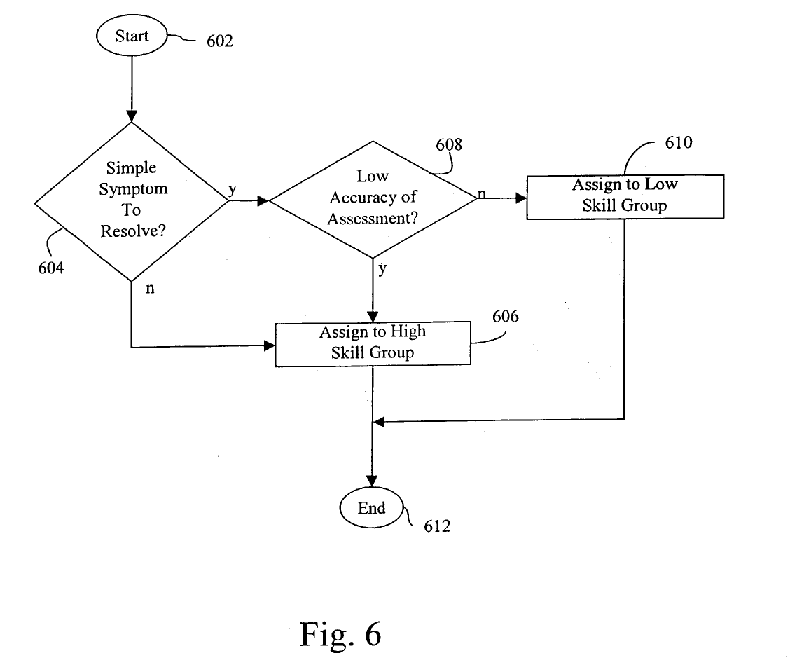

At the conclusion of the assessment process at block 516, the assignment process is initiated. Assignment behavior 318 of regional node 314 models the assignment process as shown in FIG. 6.

The assignment process begins at block 602 and proceeds to decision block 604 wherein behavior 318 models an evaluation by the assessor as to whether they predict that the problem is a simple problem to resolve or whether it is a complex problem to resolve. This predictive evaluation may be simulated by probabilistic distributions so that, for example, a percentage of problems are deemed “simple” to resolve and a percentage of problems are deemed “complex” to resolve. If assignment behavior 318 simulates an assessor's conclusion that the problem is a complex problem to resolve, then resolution duties are assigned to a highly skilled group as indicated at control block 606 which proceeds directly to the end of the assignment process at block 612. If, however, assignment behavior 318 simulates an assessor's conclusion that the problem is a simple problem to resolve, then assignment behavior 318 considers the accuracy of the assessment indicator compounded in the assessment process. If the accuracy assessment indicator is less than a predetermined threshold at decision block 608, then behavior 318 simulates the assignment of the problem to a highly skilled resolution group at control block 606 because the circumstances surrounding the reported incident are less defined. Alternatively, if the accuracy of assessment indicator is greater than a predetermined threshold at decision block 608, then assignment behavior 318 simulates the assignment of the problem to a less skilled resolution group at control block 610 because the assessor's assessment is that the problem is simple to resolve and the circumstances surrounding the reported incident are well-defined. In either event, the assignment process ends at control block 612 and the termination process begins.

Subsequent to completion of the assignment process at node 314, software-related symptoms propagate to software resolution node 320, hardware-related symptoms propagate to hardware resolution node 322, system-related symptoms propagate to system resolution node 332, and HCI symptoms propagate to HCI resolution node 334. As noted above, each node 320, 322, 332, 334 comprises two behaviors, wherein one behavior models a highly skilled resolution working group and one behavior models a less skilled resolution working group. A less skilled resolution working group will have less skill, training, or expertise than those of a highly skilled resolution working group. The assignment process assigns each symptom to its relevant node and resolution behavior.

FIG. 7 shows control flow according to the termination process simulated by nodes 320, 322, 332, 334 and their associated resolution behaviors. The process begins at block 702 and proceeds to control block 704, wherein a level of difficulty of the problem is generated. The level of difficulty models the degree of difficulty of the problem in view of the expertise of the resolution working group. For example, there may be a lower level of difficulty for a high skilled resolution working group resolving a complex problem (as evaluated by the assessor in the assignment process described above) than for a less skilled resolution working group resolving the same complex problem. It is important to note that this level of difficulty does not relate to the predictive evaluation by the assessor at control block 604 in FIG. 6. The level of difficulty influences the duration of the simulated running time of the termination process, which becomes lengthier with an increasing level of difficulty. Also, the level of difficulty influences a resolution accuracy indicator generated at control block 706.

The resolution accuracy indicator is generated to measure the degree of accuracy to which a problem is resolved. The resolution accuracy indicator may be conditioned on three factors. The first factor is the level of difficulty of the problem as described above. The second factor is the type of problem, such as hardware-related, software-related, system-related, or HCI-related, that is being resolved. Some types of problems may be resolved with more accuracy then others. The third factor is the level of expertise of the resolving group, for example, a highly skilled resolution group or a less skilled resolution group. A higher skilled group will generally engender a higher resolution accuracy indicator.

Also, it should be noted that the model might not simulate a resolution at all, and instead simulate a NTF situation, which would be reflected by a low resolution accuracy indicator.

Following the convolution of these four factors, an accuracy in toto indicator is engendered at control block 708. In one embodiment, the accuracy in toto indicator is the multiplicative product of the assessment accuracy indicator and the resolution accuracy, with the assessment accuracy indicator being de-emphasized by a weighting factor and the resolution accuracy indicator being weighted appropriately according to the level of data fusion for problem resolution. The assessment accuracy indicator may be de-emphasized because the resolution groups often have more expertise in dealing with imperfect information than the assessors. It should be noted than the data fusion for problem resolution is distinct from the data fusion used in the assessment process.

At control block 710, results from model 300 may be output for analyzing the level of efficiency of the problem resolution process. Such results may include the incident type, a running tally of the incidents, the assessment accuracy indicator, the resolution accuracy indicator, the accuracy in toto indicator, running assessment time, running assignment time, running resolution time, total running time, and the levels of data fusion and automation used throughout the modeled problem resolution process. The termination process ends at block 712.

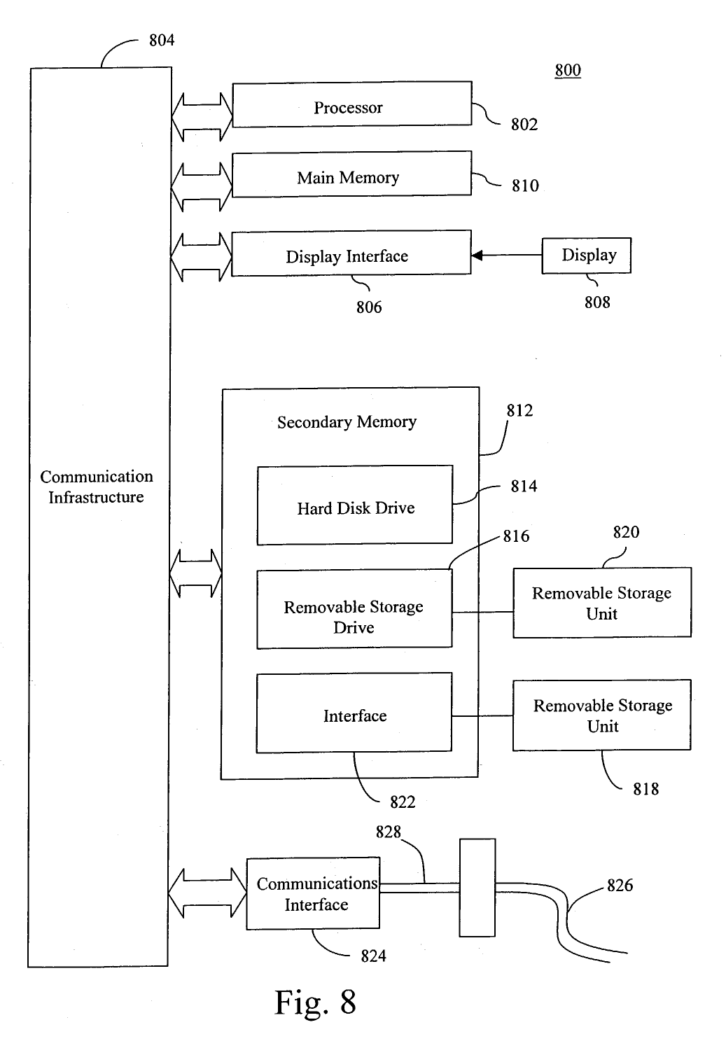

The present invention may be implemented using hardware, software or a combination thereof and may be implemented in one or more computer systems or other processing systems. In fact, in one embodiment, the invention is directed toward one or more computer systems capable of carrying out the functionality described herein. An example of a computer system 800 is shown in FIG. 8. Computer system 800 includes one or more processors, such as processor 802. Processor 802 is connected to a communication infrastructure 804 (e.g., a communications bus, cross-over bar, or network). Various software embodiments are described in terms of this exemplary computer system. After reading this description, it will become apparent to a person skilled in the relevant art(s) how to implement the invention using other computer systems and/or computer architectures.

Computer system 800 can include a display interface 806 that forwards graphics, text, and other data from communication infrastructure 804 (or from a frame buffer not shown) for display on a display unit 808.

Computer system 800 also includes a main memory 810, preferably random access memory (RAM), and may also include a secondary memory 812. Secondary memory 812 may include, for example, a hard disk drive 814 and/or a removable storage drive 816, representing a floppy disk drive, a magnetic tape drive, an optical disk drive, etc. Removable storage drive 816 reads from and/or writes to a removable storage unit 818 in a well-known manner. Removable storage unit 818, represents a floppy disk, magnetic tape, optical disk, etc. which is read by and written to by removable storage drive 818. As will be appreciated, removable storage unit 818 includes a computer usable storage medium having stored therein computer software and/or data.

In alternative embodiments, secondary memory 814 may include other similar means for allowing computer programs or other instructions to be loaded into computer system 800. Such means may include, for example, a removable storage unit 820 and an interface 822. Examples of such may include a program cartridge and cartridge interface (such as that found in video game devices), a removable memory chip (such as an EPROM, or PROM) and associated socket, and other removable storage units 820 and interfaces 822 which allow software and data to be transferred from the removable storage unit 820 to computer system 800.

Computer system 800 may also include a communication interface 824. Communications interface 824 allows software and data to be transferred between computer system 800 and external devices. Examples of communications interface 824 may include a modem, a network interface (such as an Ethernet card), a communications port, a PCMCIA slot and card, etc. Software and data transferred via communications interface 824 are in the form of signals 826 which may be electronic, electromagnetic, optical or other signals capable of being received by communications interface 824. These signals 826 are provided to communications interface 824 via a communications path (i.e., channel) 828. This channel 828 carries signals 826 and may be implemented using wire or cable, fiber optics, a phone line, a cellular phone link, an RF link and other communications channels.

In this document, the terms “computer program medium” and “computer usable medium” are used to generally refer to media such as removable storage drive 816, a hard disk installed in hard disk drive 814, and signals 826. These computer program products are means for providing software to computer system 800. The invention is directed to such computer program products.

Computer programs (also called computer control logic) are stored in main memory 810 and/or secondary memory 812. Computer programs may also be received via communications interface 822. Such computer programs, when executed, enable computer system 800 to perform the features of the present invention as discussed herein. In particular, the computer programs, when executed, enable processor 802 to perform the features of the present invention. Accordingly, such computer programs represent controllers of computer system 800.

In an embodiment where the invention is implemented using software, the software may be stored in a computer program product and loaded into a computer system 800 using removable storage drive 816, hard drive 814 or communications interface 824. The control logic (software), when executed by processor 802, causes processor 802 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

While this invention has been described in conjunction with specific embodiments thereof, it is evident that many alternatives, modifications and variations will be apparent to those skilled in the art. Accordingly, the preferred embodiments of the invention as set forth herein, are intended to be illustrative, not limiting. Various changes may be made without departing form the true spirit and full scope of the invention as set forth herein and defined in the claims.

1. A computer-implemented method for modeling a distributed workload problem resolution process comprising the steps of:
building a topological model of a workload process comprising a plurality of hierarchical levels, each level comprising at least one node;
assigning at least one behavior to each node, the behavior configured to model a component of the problem resolution process; and
wherein at least one of the behaviors is configured to model a degree of merit.

2. The method of claim 1, further comprising the steps of:
executing the model; and
outputting data configured to represent a level of efficiency of the problem resolution process.

3. The method of claim 1, wherein the degree of merit includes a level of data fusion.

4. The method of claim 1, wherein the degree of merit includes a level of automation.

5. The method of claim 1, wherein the degree of merit includes a level of data fusion and a level of automation.

6. The method of claim 1, wherein at least one behavior is configured to model a problem assessment process.

7. The method of claim 6, wherein an accuracy of assessment indicator is derived from the degree of merit.

8. A computer readable medium having stored thereon one or more sequences of instructions for causing one or more microprocessors to perform steps for modeling a distributed workload problem resolution process, the steps comprising:
building a topological model of a workload process comprising a plurality of hierarchical levels, each level comprising at least one node;
assigning at least one behavior to each node, the behavior configured to model a component of the problem resolution process; and
wherein at least one of the behaviors are configured to model a degree of merit.

9. The computer readable medium of claim 8, further comprising the steps of:
executing the model; and
outputting data configured to represent a level of efficiency of the problem resolution process.

10. The computer readable medium of claim 8, wherein the degree of merit includes a level of data fusion.

11. The computer readable medium of claim 8, wherein the degree of merit includes a level of automation.

12. The computer readable medium of claim 8, wherein the degree of merit includes a level of data fusion and a level of automation.

13. The computer readable medium of claim 8, wherein at least one behavior is configured to model a problem assessment process.

14. The computer readable medium of claim 13, wherein an accuracy of assessment indicator is derived from the degree of merit.

15. A system for modeling a distributed workload problem resolution process comprising:
an interface configured to enable a user to build a topological model of a workload process comprising a plurality of hierarchical levels, each level comprising at least one node, and further configured to assign at least one behavior to each node, the behavior configured to model a component of the problem resolution process;
a memory configured to store the topological model and the behavior configured to model the workload process; and
a processor configured to execute the model.

16. The system of claim 15, wherein the degree of merit includes a level of data fusion.

17. The system of claim 15, wherein the degree of merit includes a level of automation.

18. The system of claim 15, wherein the degree of merit includes a level of data fusion and a level of automation.

19. The system of claim 15 of claim 8, wherein at least one behavior is configured to model a problem assessment process.

20. The computer readable medium of claim 19, wherein an accuracy of assessment indicator is derived from the degree of merit.
